(19) United States
(12) Patent Application Publication
(10) Pub. No.: US 2016/0065121 A1
(43) Pub. Date: Mar. 3, 2016

(54) UNIVERSAL CASSETTE

(71) Applicant: First Solar, Inc., Perrysburg, OH (US)

(72) Inventors: Eddie Bugg, Perrysburg, OH (US); Ken Fisher, Perrysburg, OH (US); Jeffrey Lamb, Perrysburg, OH (US); John Perkins, Perrysburg, OH (US)

(21) Appl. No.: 14/838,510

(22) Filed: Aug. 28, 2015

Related U.S. Application Data
(60) Provisional application No. 62/043,545, filed on Aug. 29, 2014.

(51) Int. Cl. H02S 20/32; H02S 20/10

(52) U.S. Cl. CPC H02S 20/32; H02S 20/10

(57) ABSTRACT

A method of installing photovoltaic modules in a solar array is provided. The method includes the steps of forming one or more universal cassettes, each having a plurality of photovoltaic modules attached to one or more rails, positioning the one or more universal cassettes in a curing apparatus, securing the curing apparatus with a vehicle, moving the curing apparatus along rows of installed mounting hardware and deploying the universal cassettes from the curing apparatus and attaching the universal cassettes to the installed mounting hardware.

### CROSS-REFERENCE TO RELATED APPLICATION

This application claims the benefit of priority of U.S. Provisional Patent Application Ser. No. 62/043,545 filed on Aug. 29, 2014 hereby incorporated herein by reference in its entirety.

### BACKGROUND

Solar energy produced by the sun can be captured by photovoltaic (PV) modules. PV modules can be grouped together to form solar arrays. In some instances the solar arrays are mounted to frameworks having a fixed orientation to the sun (commonly referred to as “fixed tilt” installations). In other instances the solar arrays can be mounted on frameworks configured to track the sun's diurnal motion. Certain tracking systems include a torque tube capable of rotating a solar array of PV modules. The torque tube can be mounted on support posts, which are typically secured to the ground.

Arrays of PV modules can be arranged in parallel rows, running in a generally north-to-south direction, such that the arrays can be tilted in an east-to-west direction to track the sun's rotation. Various mechanisms, including gearboxes, motors and linkages may be used to rotate the arrays.

One issue commonly faced by the solar power industry is the labor and cost associated with the installation of the PV modules in a solar array. Since a solar power system (farm) can include many arrays and the associated frameworks, torque tubes, support posts and tracking equipment, the cost associated with the material and labor of the installed equipment may become burdensome for commercial viability.

It would be advantageous if the methods used to install arrays of PV modules could be improved.

### SUMMARY

The above objects, as well as other objects not specifically enumerated, are achieved by a method of installing photovoltaic modules in a solar array. The method includes the steps of forming one or more universal cassettes, each having a plurality of photovoltaic modules attached to one or more rails, positioning the one or more universal cassettes in a curing apparatus, securing the curing apparatus with a vehicle, moving the curing apparatus along rows of installed mounting hardware and deploying the universal cassettes from the curing apparatus and attaching the universal cassettes to the installed mounting hardware.

Various objects and advantages of the universal cassette will become apparent to those skilled in the art from the following detailed description of the preferred embodiment, when read in light of the accompanying drawings

### BRIEF DESCRIPTION OF THE DRAWINGS

FIG. 1 is a perspective view of a portion of a universal cassette illustrating a PV module attached to a plurality of rails.

FIG. 2 is a perspective view of the portion of the universal cassette of FIG. 1 shown with an additional installed PV module.

FIG. 3 is a perspective view of an assembled universal cassette.

FIG. 4 is a perspective view of a first embodiment of a manufacturing apparatus for forming the assembled universal cassette of FIG. 3.

FIG. 5 is a perspective view of a second embodiment of a manufacturing apparatus for forming the assembled universal cassette of FIG. 3.

FIG. 6 is a perspective view of a curing apparatus for the assembled universal cassette of FIG. 3.

FIG. 7 is a close-up perspective view of a portion of the curing apparatus of FIG. 6.

FIG. 8 is a side elevational view of a method of deploying cured universal cassettes in a “fixed tilt” solar power system.

FIG. 9 is a plan view of the method of FIG. 8.

FIG. 10a is a perspective view of a rail and nested rail supports.

FIG. 10b is a front elevational view of the nested rail and rail support of FIG. 10a.

FIG. 11 is a perspective view of the rail and rail supports of FIG. 10, illustrated in an extended arrangement.

FIG. 12 is a perspective view of a portion of the rail and rail supports of FIG. 11, illustrated in an assembled arrangement with a clamping member.

FIG. 13 is a perspective view of an assembled rail, rail supports and clamping member.

FIG. 14 is a side elevational view of a first method of deploying cured universal cassettes in a “tracking” solar power system.

FIG. 15 is a plan view of the method of FIG. 14.

FIG. 16 is a side elevational view of a second method of deploying cured universal cassettes in a “tracking” solar power system.

FIG. 17 is a plan view of the method of FIG. 16.

FIG. 18 is a perspective view of a forklift vehicle equipped with a work platform.

FIG. 19 is a perspective view of the forklift vehicle equipped with the work platform of FIG. 18.

FIG. 20 is a side elevational view of the forklift vehicle equipped with the work platform of FIG. 18.

FIG. 21 is a perspective view of a lifting mechanism facilitating installation of a cured universal cassette.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

The description and figures disclose a universal cassette, that is, a pre-assembled combination of multiple photovoltaic modules (hereafter “PV modules”) and rails and methods for installation of universal cassettes in a solar power system. The universal cassette is configured to reduce the time and cost required for field installation of PV modules. The universal cassette is configured for assembly within a factory setting or at the site of the solar power system. As will be discussed in more detail below, in addition to the novelty of the structure of the universal cassette, the tools, methods and techniques of installing universal cassettes are also novel. The term “photovoltaic module”, as used herein, is defined to mean any packaged and connected assembly of solar cells. The term “solar cell”, as used herein, is defined to mean any electrical device that converts the energy of light directly into electricity by a photovoltaic effect. The term “solar array”, as used herein, is defined to mean any grouping of solar cells. The term “solar power system”, as used herein, is defined to mean any grouping of solar arrays.

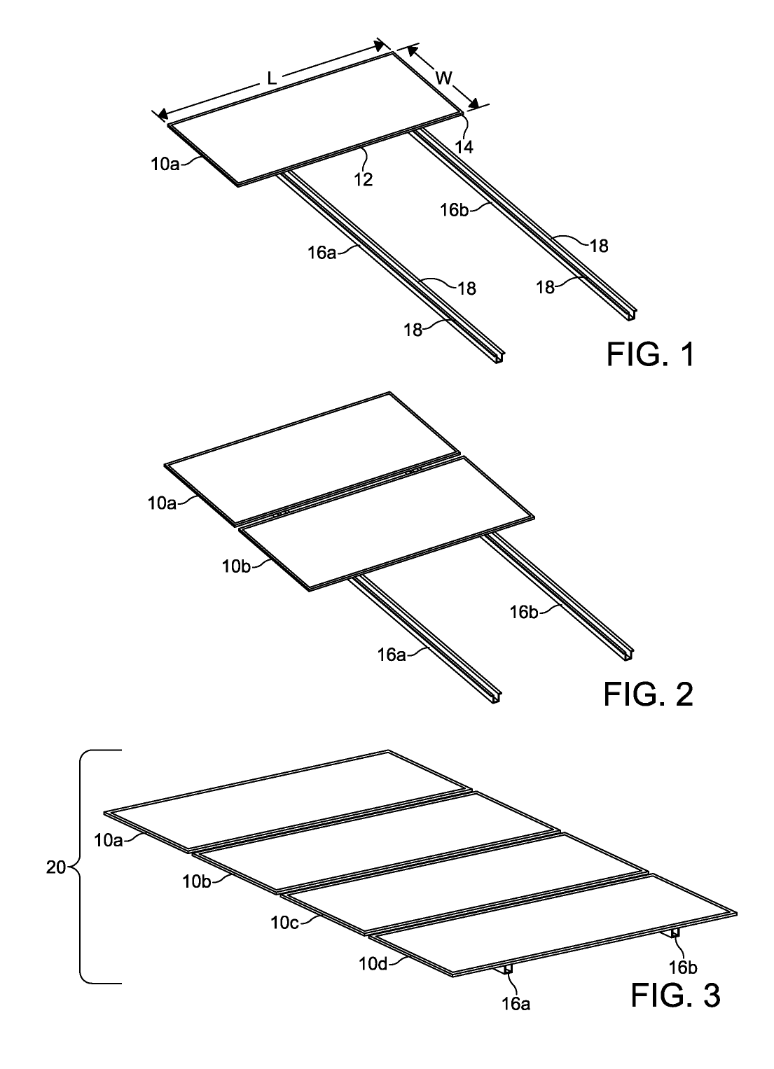

Referring now to the drawings, there is illustrated generally in FIGS. 1-3 the structures and sequential steps for forming a universal cassette. Referring first to FIG. 1, a first PV module is illustrated generally at 10a. PV modules are known in the art and will only be briefly described herein. The first PV module 10a has a transparent, conductive outer surface 12, a substrate 14 opposing the outer surface 12 and one or more layers of semiconductor materials (not shown) positioned therebetween. The first PV module 10a has a length L and a width W. In the illustrated embodiment, the length L is 48.0 inches and the width W is about 24.0 inches. However, in other embodiments, the length L can be more or less than 48.0 inches and the width W can be more or less than about 24.0 inches. The operation of the first PV module 10a is conventional in the art and will not be described herein.

Referring again to FIG. 1, the substrate 14 of the first PV module 10a is attached to one or more rails 16a, 16b. The rails 16a, 16b are configured for several functions. First, the rails 16a, 16b are configured to support multiple PV modules as a universal cassette is installed in a solar power system. Second, the rails 16a, 16b are configured to support a universal cassette as the universal cassette is stored within a temporary curing framework. Third, the rails 16a, 16b are configured for attachment to final installation frameworks.

In the embodiment illustrated in FIGS. 1-3, the rails 16a, 16b have a “U”-shaped cross-sectional shape forming attachment flanges 18. The attachment flanges 18 provide surfaces suitable for attachment to the substrate 14 of the first PV module 10a. In the alternative, the rails 16 can have any desired cross-sectional shape, sufficient to provide an attachment surface for attachment to the substrate 14 of the first PV module 10a, such as for example a hollow rectangular cross-sectional shape.

While the embodiment illustrated in FIG. 1 shows a quantity of two rails 16a, 16b, it is within the contemplation of the universal cassette that one rail or more than two rails can be used. Further, while the illustrated embodiment shows the orientation of the rails 16a, 16b to be transverse to the length L of the first PV module 10a, in other embodiments, the orientation of the rails 16a, 16b relative to the length L of the PV module 10a can be different.

In the embodiment illustrated in FIG. 1, the first PV module 10a is attached to the rails 16a, 16b with the use of one or more adhesives. Non-limiting examples of suitable adhesives include silicon-based adhesives. However, it is anticipated that other suitable adhesives can be used.

While the assembly of the embodiment shown in FIG. 1 has been described above as using chemical adhesives, it is within the contemplation of the universal cassette that the PV module 10a can be attached to the rails 16a, 16b with other structures, mechanisms and devices, such as for example, tape, clips, clamps, brackets and fasteners.

Referring now to FIG. 2 in a next assembly step, a second PV module 10b is attached to the rails 16a, 16b in the same or similar manner as described above for the first PV module 10a. The second PV module 10b is attached to the rails 16a, 16b such that the lengths and widths of the first and second PV modules 10a, 10b substantially align with each other as shown in FIG. 2.

Referring now to FIG. 3 in a next assembly step, a third and a fourth PV module 10c, 10d are shown attached to the rails 16a, 16b. The third and fourth PV modules 10c, 10d are attached to the rails 16a, 16b in the same or similar manner as described above. The combination of the first, second, third and fourth modules 10a-10d and the rails 16a, 16b form a universal cassette 20. The PV modules 10a-10d are attached to the rails 16a, 16b such that the lengths and widths of the PV modules 10a-10d substantially align with each other as shown in FIG. 3.

In the embodiment illustrated in FIG. 3, the PV modules 10a-10d are the same as, or similar to each other. However, in other embodiments, the PV modules 10a-10d can be different from each other. Further, while each of the PV modules 10a-10d have been described above as being attached to the rails 16a, 16b in the same manner, it is within the contemplation of the universal cassette 20 that the PV modules 10a-10d can be attached to the rails 16a, 16b in differing manners.

It should be appreciated that the manner of the attachment of the PV modules 10a-10d to the rails 16a, 16b facilitates the use of PV modules having the same or differing thicknesses. While the embodiment illustrated in FIG. 3 shows the PV modules 10a-10d as having the same thickness, in other embodiments, the thicknesses of the PV modules 10a-10d can be different from each other.

Advantageously the methods of manufacturing the universal cassette 20 facilitate the assembly in differing settings. As a first example, the universal cassette 20 can be manufactured in a conventional factory setting, in a location that can be substantially apart from the location of the final installation in a solar power system. As a second example, the universal cassette 20 can be manufactured at or substantially near the location of the final solar power system installation.

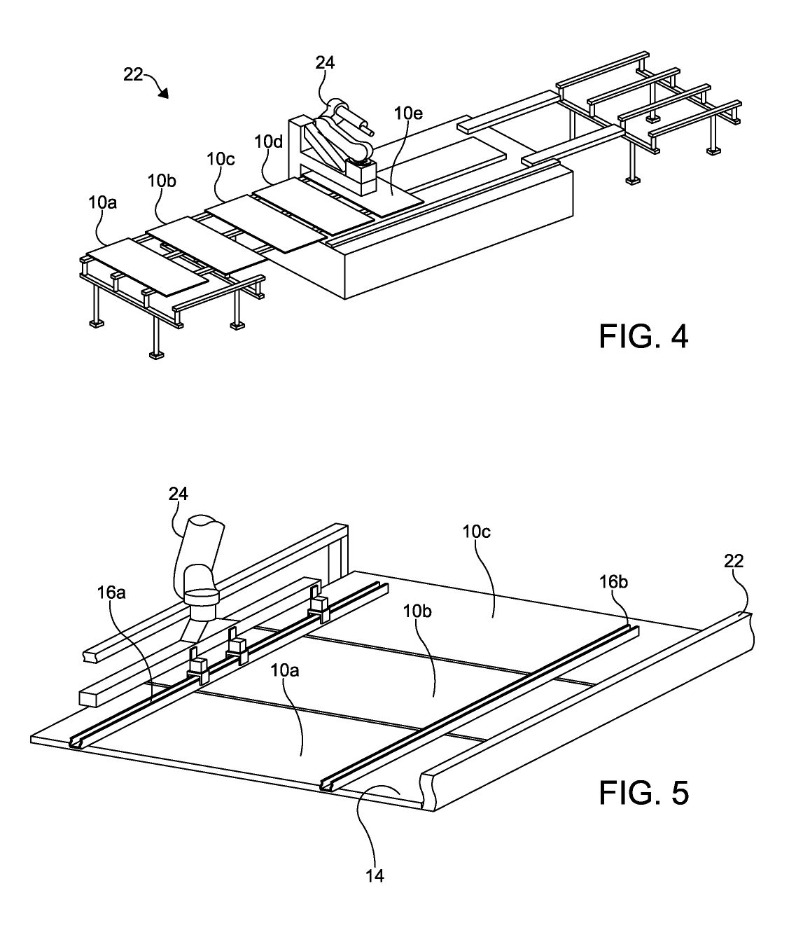

Referring now to FIGS. 4 and 5, various manufacturing apparatus configured to manufacture the universal cassette 20, near the location of the final solar power system installation are illustrated. Referring first to FIG. 4, a plurality of PV modules 10a-10e are shown positioned in a manufacturing apparatus 22. The manufacturing apparatus 22 includes various structures and devices configured to support the PV modules 10a-10e as the rails are attached to the PV modules 10a-10e. Referring now to FIG. 5, a close-up view of a portion of the manufacturing apparatus 22 is illustrated. The PV modules 10a-10c are positioned on the manufacturing apparatus 22 such that the substrates 14 of the PV modules 10a-10c are facing in an upward direction, although in other embodiments, the PV modules 10a-10c can be positioned on the manufacturing apparatus 22 such that the outer surfaces of the PV modules 10a-10c are facing in an upward direction.

Referring again to FIG. 5, the manufacturing apparatus 22 also includes a placement apparatus 24 configured to position and attach the rails 16a, 16b, to the substrate 14 using the one or more adhesives (not shown). In the embodiment illustrated in FIGS. 4 and 5, the placement apparatus 24 includes robotic mechanisms configured to automate the process of positioning and attaching the rails 16a, 16b, to the substrate 14. However, in other embodiments, the placement apparatus 24 can be any mechanism or device, including manually operated mechanisms or devices, configured to position and attach the rails 16a, 16b, to the substrate 14 of the PV modules.

Referring again to FIGS. 4 and 5, in the event the universal cassettes are manufactured at or substantially near the location of the final installation, significant benefits can be realized, including reduced costs for transportation of the universal cassettes and enhanced logistical/inventory control by the construction manager.

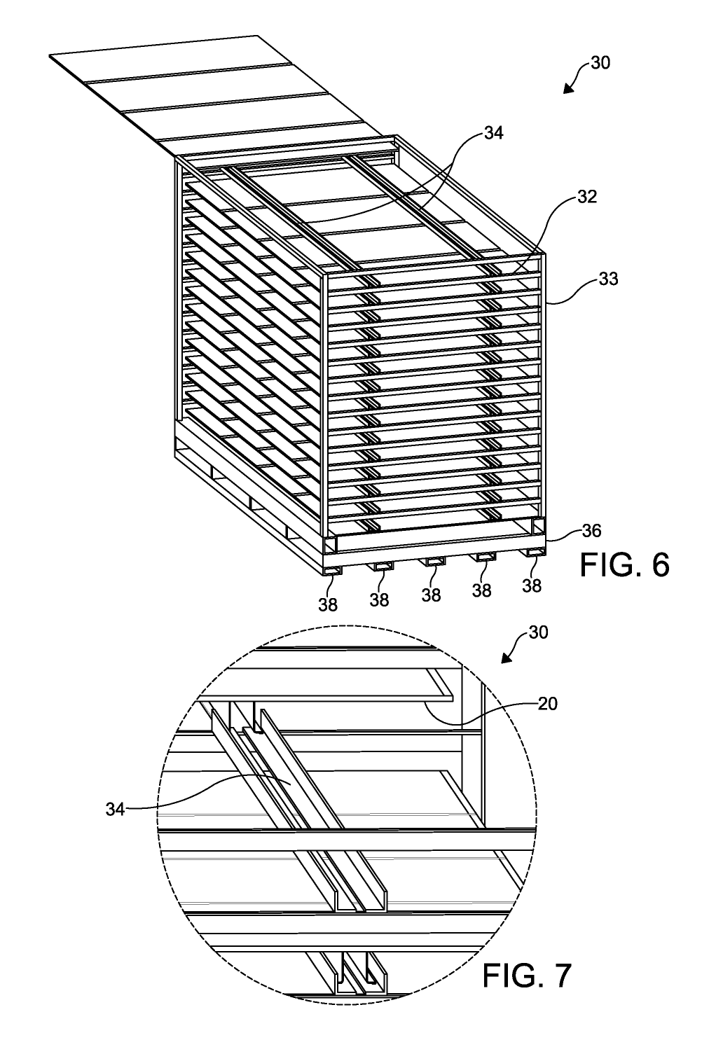

Referring now to FIGS. 6 and 7, each newly assembled universal cassette is placed in a curing apparatus, shown generally at 30. The curing apparatus 30 is configured for several functions. First, the curing apparatus 30 is configured as a holding device for a plurality of universal cassettes 30 as the adhesives attaching the PV modules to the rails cures. In certain embodiments, the curing time for the adhesives can be in a range of from about 2.0 hours to about 6.0 hours. However, it should be appreciated that in other embodiments, the curing time for the adhesives can be less than about 2.0 hours or more than about 6.0 hours. Second, as will be explained in more detail below, the curing apparatus 30 may be used as a deployment device during the installation of the universal cassettes 30 in a solar power system.

Referring first to FIG. 6, the curing apparatus 30 includes a plurality of spaced apart and stacked levels, formed within a framework 33. A representative level is shown generally at 32. While the embodiment of the curing apparatus 30 illustrated in FIG. 6 shows a quantity of fifteen (15) levels 32, in other embodiments the curing apparatus 30 can have more or less than fifteen (15) levels 32.

Referring now to FIGS. 6 and 7, each level 32 includes one or more spaced apart guides 34, attached to the framework 33 and configured to receive the rails 14a, 14b as each universal cassette 20 is inserted into a level 32. The guides 34 are further configured to retain the universal cassettes 20 and allow the adhesive attaching the PV modules to the rails to cure in an undisturbed manner. The universal cassettes 20 with the cured adhesives form cured universal cassettes 21.

In the embodiment shown in FIG. 7, the guides 34 are formed by opposing structural members having an “L” cross-sectional shape. However, in other embodiments, the guides 34 can be formed from other members having any desired cross-sectional shape, sufficient to receive the rails of the universal cassette and sufficient to allow the adhesive attaching the PV modules to the rails to cure in an undisturbed manner.

Referring again to FIG. 6, a bottom portion 36 of the framework 33 includes a plurality of spaced apart members 38 configured to receive forks (not shown) of a forklift vehicle, in a manner that the curing apparatus 30 can be moved and used as a deployment device during the installation of the universal cassettes in a solar power system. In the illustrated embodiment, the members 38 are hollow and have a rectangular cross-sectional shape. Alternatively, the members 38 can have any shape sufficient to receive forks of a forklift truck, in a manner that the curing apparatus 30 can be moved and used during the installation of the universal cassettes in a solar power system. In other embodiments, the bottom portion 36 of the framework 30 can be configured to receive the forks of a forklift vehicle between the spaced apart members 38. In still other embodiments, optionally the framework 33 can be fitted with wheels or rollers to facilitate movement of the curing apparatus 30.

Referring again to FIG. 6, the framework 33 of the curing apparatus 30 provides that the plurality of levels 32 are sufficiently spaced apart so as to allow a free flow of air over the adhered rails and substrates, thereby facilitating the curing of the adhesives. Optionally, the curing apparatus 30 can be fitted with mechanisms and/or devices to facilitate the movement of forced air over the adhered rails and substrates. Non-limiting examples of mechanisms and/or devices for forcing air over the adhered rails and substrates include fans and vacuum devices.

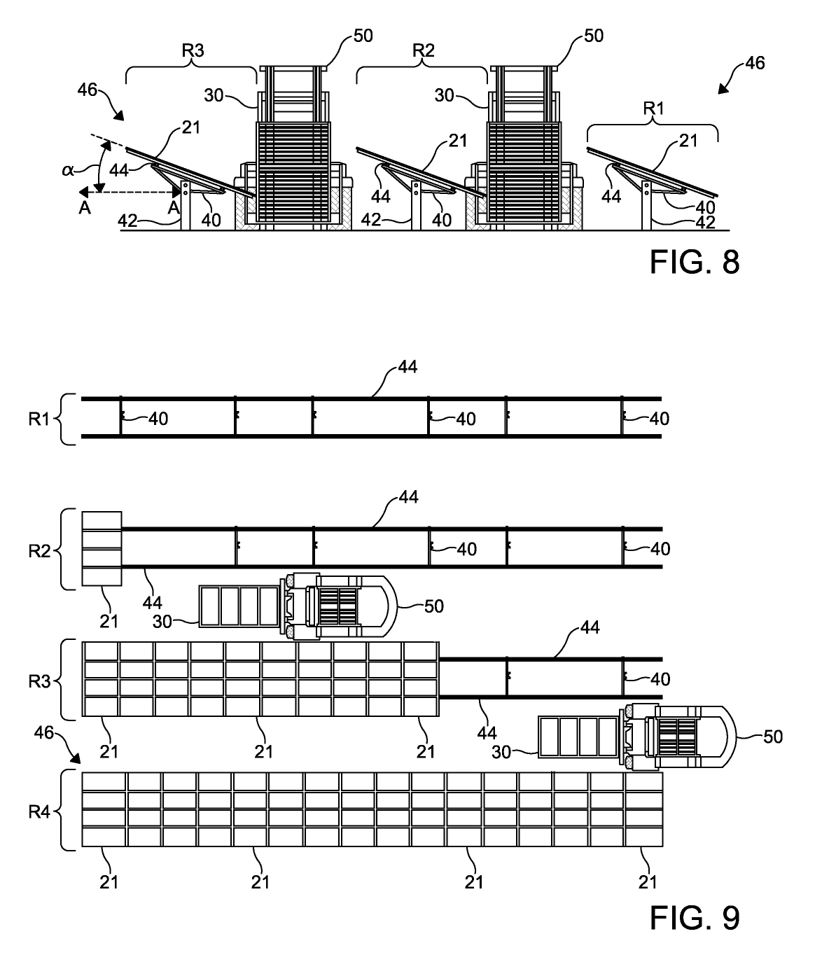

Referring now to FIGS. 8 and 9, one method of installing the cured universal cassettes 21 in a “fixed tilt” solar power system is illustrated. Referring first to FIG. 8, tilt brackets 40 are attached to posts 42 and beams 44 are attached to the tilt brackets 40 such as to span any desired number of tilt brackets 40. A first row R1 is formed by aligned tilt brackets 40, posts 42, and beams 44. In a similar manner, additional rows R2, R3 of aligned tilt brackets 40, posts 42, and beams 44 can be formed formed. A plurality of cured universal cassettes 21 are attached to the beams 44, thereby forming a solar array 46. As will be explained in more detail below, the curring apparatus 30 can be used in a various ways to facilitate installation of the cured universal cassettes 21.

Referring again to FIG. 8, the mounting members 40 form an angle α with a generally horizontal axis A--A. In the illustrated embodiment, the angle α is in a range of from about 15° to about 40°. Alternatively, the angle α can be less than about 15° or more than about 40° , as desired.

Referring now to FIG. 9, the sequential installation steps for forming the solar arrays 46 shown in row R4 are illustrated. In a first installation step, portions of row R1 are assembled from tilt brackets 40 attached to posts (not shown) and beams 44 are attached to the tilt brackets 40 thereby spanning any desired number of posts. In subsequent steps, portions of rows R2, R3 and R4 are formed in a similar manner. In a next step, as illustrated between rows R2 and R3, a curing apparatus 30 having a plurality of cured universal cassettes 21, is secured by a forklift vehicle 50. The forklift vehicle 50 is moved in a direction parallel to the rows R2 and R3, such that the cured universal cassettes 21 can be lifted to an appropriate height and deployed from the curing apparatus 30 and attached to the beams 44. After deployment of a cured universal cassette 21, the forklift vehicle 50 moves the curing apparatus 30 to a next open position on the beams 44 and raises the curing apparatus 30 for deployment of the next cured universal cassette 21. By raising the curing apparatus 30 at each subsequent installation of a cured universal cassette 21, the next cured universal cassette 21 is substantially positioned at a level that the next cured universal cassette 21 can be installed without significant effort and labor. This process is repeated until all of the cured universal cassettes 21 forming the array 46 are installed.

As shown in FIG. 9, one or more forklift vehicles 50, each having a curing apparatus 30 with cured universal cassettes 21 can be used to form the rows R1-R4. The deployment of the cured universal cassettes 21 continues until a completed solar array 46 is assembled, as shown in row R4. Advantageously, the installation of the cured universal cassettes can be completed in “one pass” by the installation personal, thereby reducing installation time and cost.

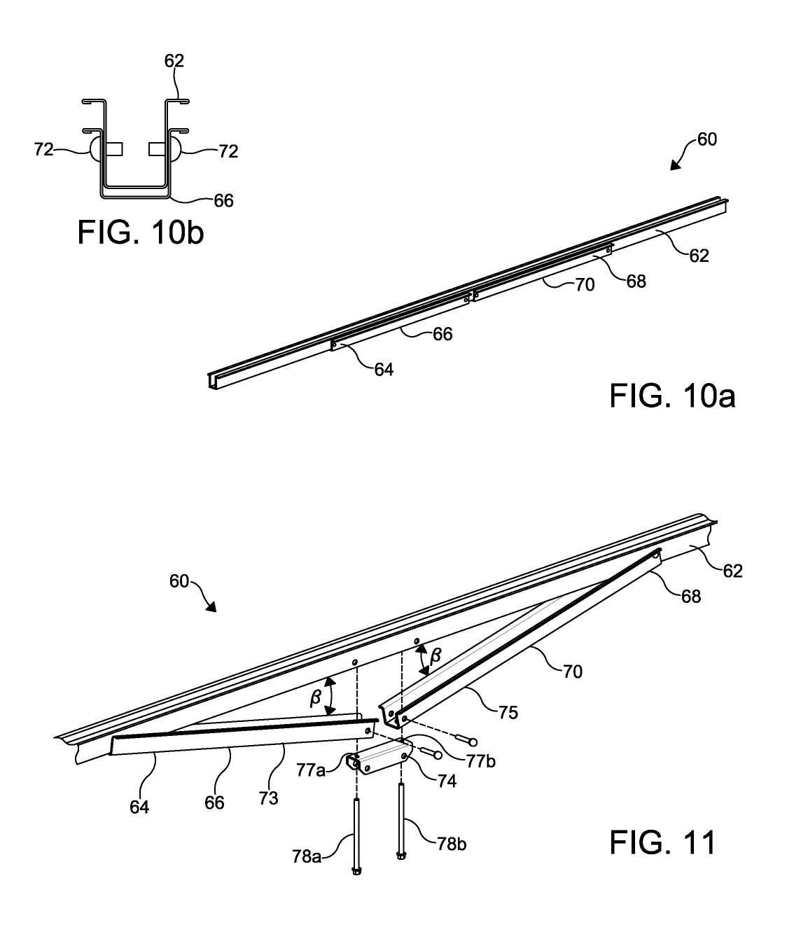

As discussed above, in certain instances solar arrays can be mounted on frameworks configured with mechanisms for tracking the sun's diurnal motion. Referring now to FIGS. 10a, 10b and 11-13, novel mounting hardware for use with single axis tracking solar arrays is illustrated at 60. Generally, the mounting hardware 60 includes one or more rail supports fastened to rails prior to shipment of the cured universal cassettes 21.

Referring now to FIG. 10a, a rail 62 is illustrated. In the illustrated embodiment, the rail 62 is the same as, or similar to, the rails 16a, 16b shown in FIGS. 1 and 2 and discussed above. In other embodiments, the rail 62 can be different than the rails 16a, 16b. The rail 62 is adhered to a PV module (not shown) as discussed above. A first end 64 of a first rail support 66 is rotatably attached to the rail 62 and a first end 68 of second rail support 70 is also rotatably attached to the rail 62. As shown in FIG. 10a, the rail supports 66, 70 are arranged in a nested position, that is, the rail supports 66, 70 are rotated such that the body of each rail support 66, 70 is positioned adjacent the rail 62. In certain embodiments, the cured universal cassettes can be shipped to an installation site with the rail supports 66, 70 installed and arranged in the nested position. In other embodiments, the rail supports 66, 70 can be installed at the site of the solar power system.

Referring now to FIG. 10b, a cross-sectional view of the rail support 66 is shown in the nested position with the rail 62. The rail support 66 is attached to the rail 62 with pins 72, although other attachment means can be used suitable to allow the first and second rail supports to rotate.

Referring now to FIG. 11, the rail supports 66, 70 are illustrated in an extended arrangement, thereby forming an angle β with the rail 62. In the extended arrangement, a second end 73 of the first rail supports 66 is attached to a clamping member 74 with a suitable fastener. Similarly, a second end 75 of the second rail support 70 is attached to the clamping member 74 with a similar suitable fastener.

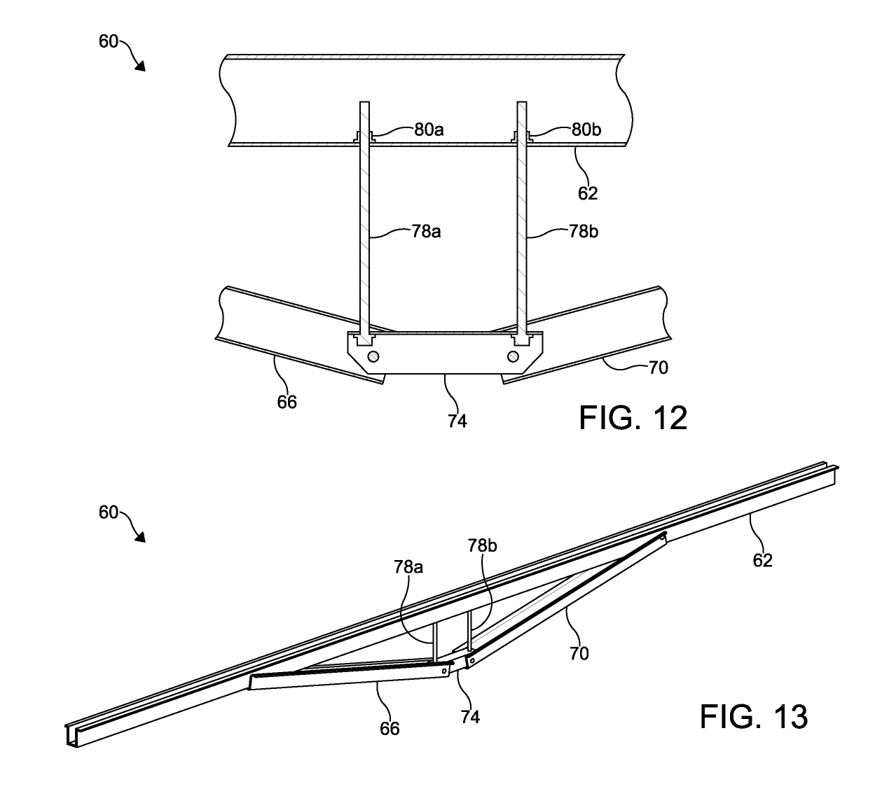

Referring again to FIG. 11, the clamping member 74 includes a plurality of apertures 77a, 77b. Connecting members 78a, 78b extend through the apertures 77a, 77b in the clamping member 74 and engage fasteners 80a, 80b positioned at the rail 62 as shown in FIG. 12. Tightening of the connecting members 78a, 78b with the fasteners 80a, 80b allows the combination of the rail 62, the support members 66, 70 and the clamping member 74 to form a sound structural assembly for subsequent attachment to the solar array tracking framework. Used in this manner, the combination of the support members 66, 70 and the clamping member 74 and the bonding of the rail to the PV module increases the buckling resistance of the rail 62, thereby advantageously allowing the use of lighter or thinner gauge rails 62.

The mounting hardware 60, including the rail 62, rail supports 66, 70, clamping member 74 and connecting members 78a, 78b are shown in an assembled state in FIG. 13.

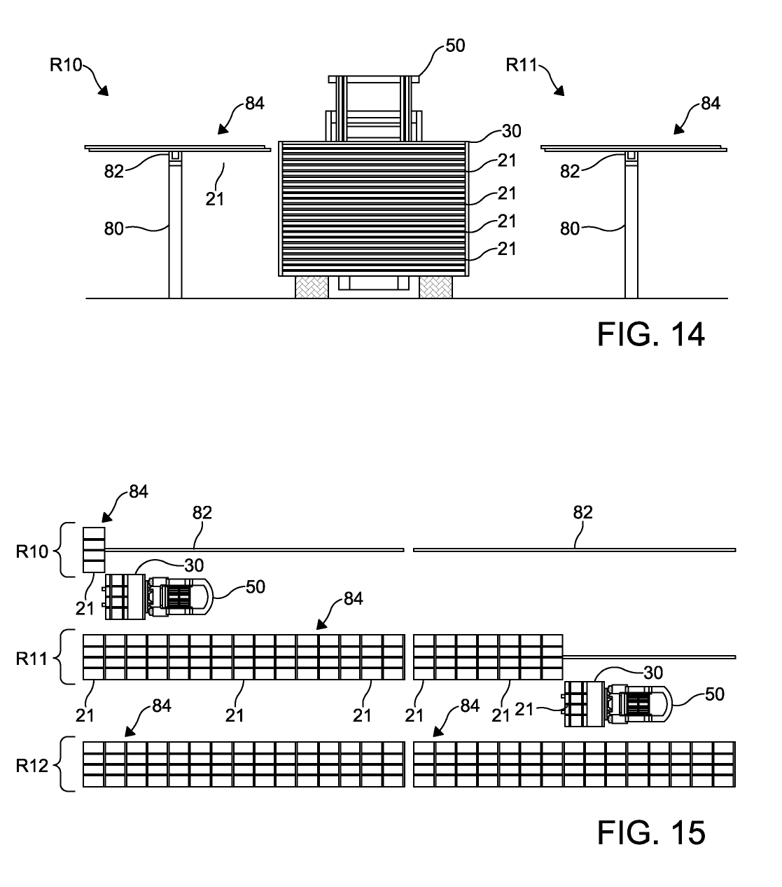

Referring now to FIGS. 14 and 15, a first method of installing cured universal cassettes 21 in a “single axis tracking” solar power system is illustrated. Referring first to FIG. 14, a first row R10 is formed by aligned posts 80 and torque tubes 82. In a similar manner, adjacent row R11 can be formed formed. A plurality of cured universal cassettes 21 are attached to the torque tubes 82 using the mounting hardware 60 described above, thereby forming a solar arrays 84.

Referring again to FIGS. 14 and 15, the sequential installation steps for forming the solar arrays 84 shown in row R10 are illustrated. In a first installation step, portions of row R10 are assembled from beams 82 attached to posts (not shown), the torque tubes 82 spanning any desired number of posts. In subsequent steps, portions of rows R11 and R12 are formed in a similar manner. In a next step, as illustrated between rows R10 and R11, a curing apparatus 30 having cured universal cassettes 21, is secured by a forklift vehicle 50. The forklift vehicle 50 is moved in a direction parallel to the rows R10 and R11, such that the cured universal cassettes 21 can be deployed from the curing apparatus 30 and attached to the torque tubes 82. As shown in FIG. 15, one or more forklift vehicles 50, each having a curing apparatus 30 with cured universal cassettes can be used to form the rows R10-R12. The deployment of the cured universal cassettes 21 continues until a solar array 84 is formed as shown in row R12. Advantageously, the installation of the cured universal cassettes 21 can be completed in “one pass” by the installation personal, thereby reducing installation time and cost.

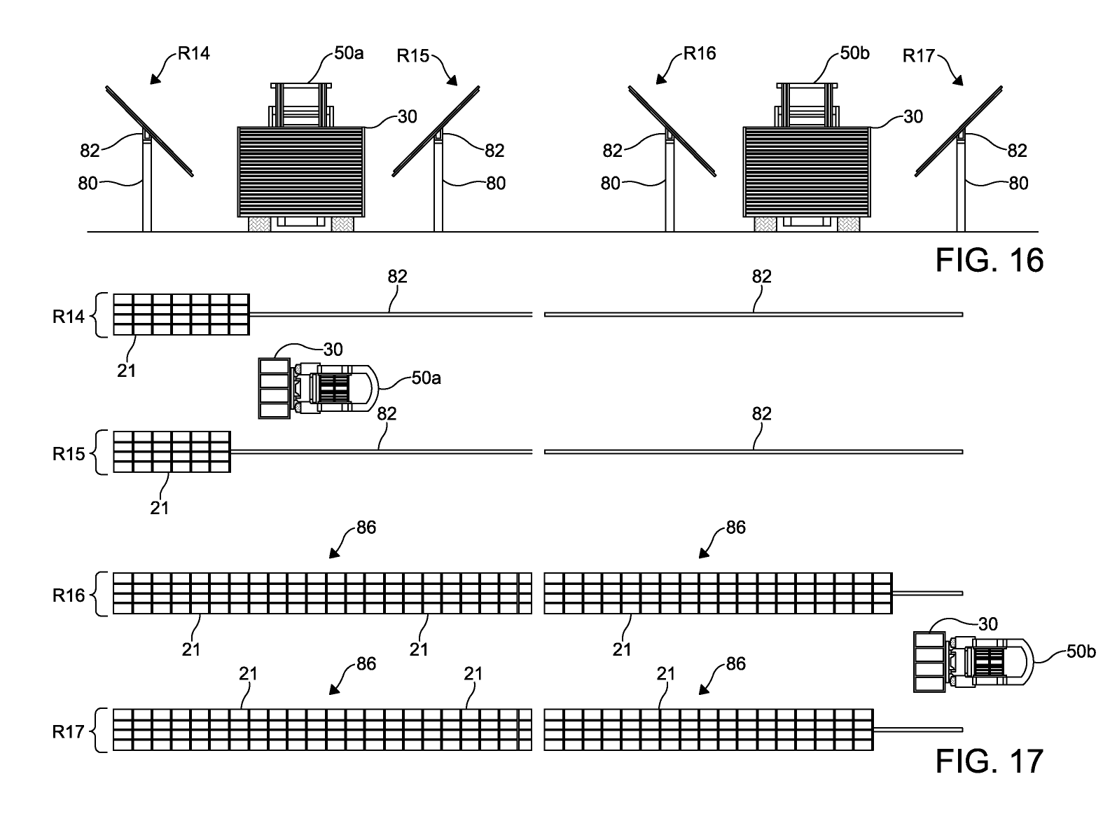

Referring now to FIGS. 16 and 17, a second method of installing the cured universal cassettes in a “single axis tracking” solar power system is illustrated. In this method, a single forklift vehicle is used to equip adjacent rows with cured universal cassettes. Referring first to FIG. 16, row R14, R15, R16 and R17 are formed by aligned posts 80 and torque tubes 82 in a manner similar to that discussed above.

Referring again to FIGS. 16 and 17, a curing apparatus 30 having cured universal cassettes 21, is secured by a forklift vehicle 50. The forklift vehicle 50 is moved in a direction parallel to the rows R14 and R15, such that the cured universal cassettes 21 can be deployed from the curing apparatus 30 and attached to the beams 82 simultaneously in rows R14 and 15. As shown in FIG. 17, a first forklift vehicles 50a forms rows R14 and R15 and a second forklift vehicle 50b is used to form the rows R16 and R17. The deployment of the cured universal cassettes 21 continues until solar arrays 86 are formed in adjoining rows as shown in rows R16 and R17. Advantageously, the installation of the cured universal cassettes 21 in adjoining rows can be completed in “one pass” by the installation personal, thereby reducing installation time and cost.

As discussed above, the curing apparatus 30 can used used to facilitate deployment of the cured universal cassettes 21 at the solar power systems. In certain applications, the curing apparatus 30 can be used in conjunction with a forklift vehicle 50. One embodiment of using the curing apparatus 30 with a forklift vehicle 50 is shown in FIGS. 8, 9 and 14-17. In this embodiment, the forklift vehicle 50 engages the curing apparatus 30 and the cured universal cassettes 21 are offloaded for attachment to the various mounting hardware.

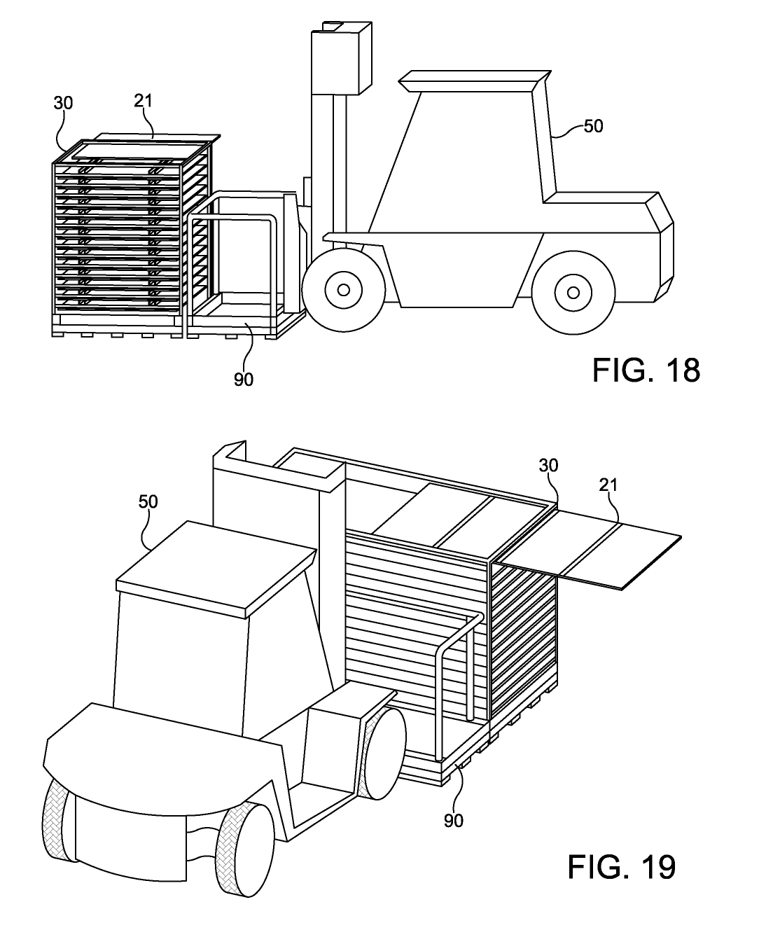

Another embodiment of using a curing apparatus 30 engaged by a forklift vehicle 50 is shown in FIGS. 18-20. In this embodiment, a curing apparatus 30 is engaged by a forklift vehicle 50 having a work platform 90. The work platform 90 is configured as a mobile scaffold, thereby allowing installation personal to access and deploy the cured universal cassettes 21 from the work platform 90. While the work platform 90 is shown positioned between the forklift vehicle 50 and the curing apparatus 30, it should be appreciated that the work platform 90 can be positioned in other arrangements relative to the forklift vehicle 50 and the curing apparatus 30, such as for example, positioning the work platform 90 on an opposite side of the curing apparatus 30 from the forklift vehicle 50. Optionally, the work platform 90 can be equipped with any desired safety structures or devices, such as the non-limiting examples of guard rails and fall protection devices.

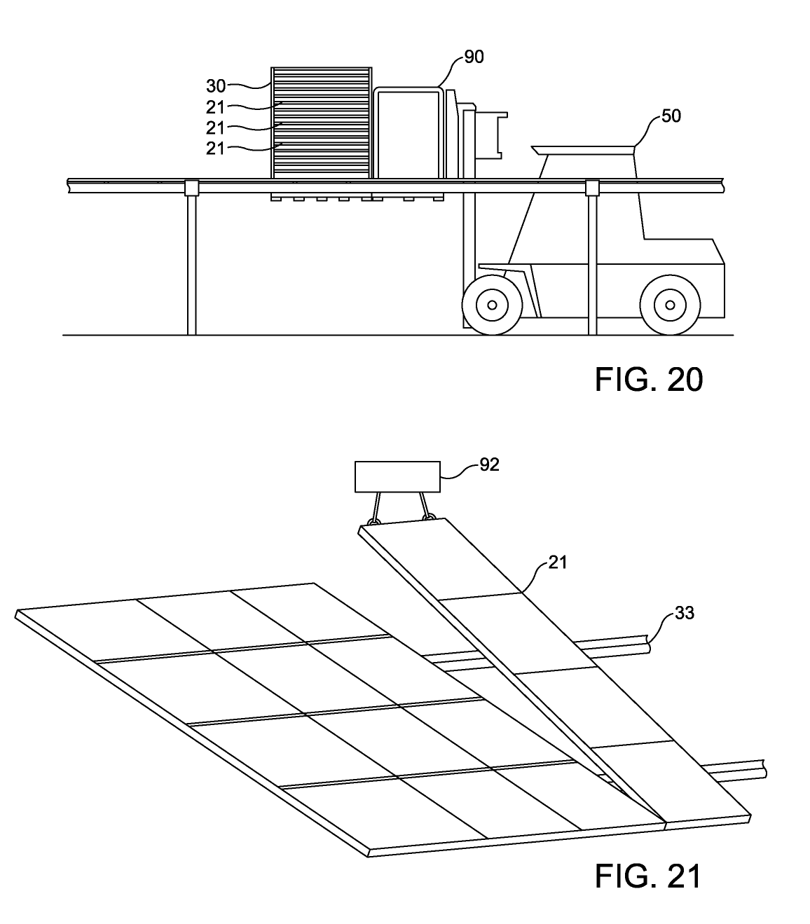

Advantageously, the combination of the forklift vehicle 50, the engaged curing apparatus 30 and the work platform 90 facilitates deployment of the cured universal cassettes 21 at different vertical heights. FIGS. 18 and 19 illustrate the positioning of the curing apparatus 30 and the work platform 90 at certain vertical heights. FIG. 20 illustrates the positioning of the curing and the work platform at a different vertical height. Each of these relative positions advantageously facilitates efficient deployment of the cured universal cassettes 21.

In still another embodiment, a cured universal cassette 21 can be installed with other mechanisms, devices and/or structures. Referring now to FIG. 21, a cured universal cassette 21 is suspended from a lifting mechanism, shown schematically at 92. The lifting mechanism 92 is configured to support the cured universal cassette 21 as the cassette 21 is attached to the framework 33. Non-limiting examples of suitable lifting mechanisms include cranes, hoists, and derricks.

The principle and mode of operation of the universal cassette has been described in its preferred embodiments. However, it should be noted that the universal cassette may be practiced otherwise than as specifically illustrated and described without departing from its scope.

What is claimed is:

1. A method of installing photovoltaic modules in a solar array, the method comprising the steps of:
forming one or more universal cassettes, each having a plurality of photovoltaic modules attached to one or more rails;
positioning the one or more universal cassettes in a curing apparatus;
securing the curing apparatus with a vehicle;
moving the curing apparatus along rows of installed mounting hardware; and
deploying the universal cassettes from the curing apparatus and attaching the universal cassettes to the installed mounting hardware.

2. The method of claim 1, wherein the installed mounting hardware forms a fixed tilt solar power system.

3. The method of claim 1, wherein the installed mounting hardware forms a single axis tracking solar power system.

4. The method of claim 1, wherein the photovoltaic modules are adhered to the one or more rails with adhesives.

5. The method of claim 1, wherein each of the photovoltaic modules have a thickness, and wherein each of the thicknesses are the same.

6. The method of claim 1, wherein the one or more rails each has a “U” shaped cross-sectional shape.

7. The method of claim 1, wherein the curing apparatus has a plurality of levels, each level configured for a single universal cassette.

8. The method of claim 7, wherein each level has one or more guides configured to receive the rails of the universal cassette.

9. The method of claim 7, wherein the curing apparatus has a quantity of fifteen levels.

10. The method of claim 1, wherein the curing apparatus is configured for movement by the vehicle.

11. The method of claim 10, wherein the vehicle is a forklift vehicle.

12. The method of claim 11, wherein the forklift vehicle includes a work platform.

13. The method of claim 11, wherein the forklift vehicle is configured to raise and lower the height of the curing apparatus.

14. The method of claim 1, wherein the curing apparatus is moved along a single row of installed mounting hardware such that deployment the universal cassettes from the curing apparatus and attachment of the universal cassettes to the installed mounting hardware is limited to that row.

15. The method of claim 1, wherein the curing apparatus is moved along adjacent rows of installed mounting hardware such that deployment the universal cassettes from the curing apparatus and attachment of the universal cassettes to the installed mounting hardware is accomplished simultaneously to the adjacent rows.

16. The method of claim 1, wherein the step of attaching the plurality of photovoltaic modules to the rails is accomplished substantially at the site of the solar array.

17. The method of claim 1, wherein the one or more rails have nested rail supports.

18. The method of claim 17, wherein the rail supports are rotatably attached to the one or more rails.

19. The method of claim 17, wherein in an extended position, the rail supports are joined by a clamping member.

20. The method of claim 19, wherein the clamping member is configured for attachment to the installed mounting hardware.
